(19) United States
(12) Patent Application Publication
(10) Pub. No.: US 2021/0037612 A1
(43) Pub. Date: Feb. 4, 2021

(54) HEATING UNIT OF MULTI-CHAMBER TYPE

(71) Applicant: AJIN INDUSTRIAL CO., LTD., Gyeongsan-si Gyeongsangbuk-do (KR)

(72) Inventors: Soon-deok KWON, Gyeongsan-si Gyeongsangbuk-do (KR); Doo-sik MIN, Daegu (KR); Seung-hyun KIM, Daegu (KR)

(21) Appl. No.: 16/607,344

(22) PCT Filed: Jun. 14, 2018
(86) PCT No.: PCT/KR2018/006695

§ 371 Date: Oct. 22, 2019

(30) Foreign Application Priority Data
May 31, 2018 (KR) 10-2018-0062737

(51) Int. Cl. H05B 3/06; B21D 22/02; B21D 37/16

(52) U.S. Cl. CPC H05B 3/06; B21D 37/16; B21D 22/022

(57) ABSTRACT

Provided is a multi-chamber type heating unit which occupies a small installation space and can effectively perform a heating process of a blank. The multi-chamber type heating unit to heat a blank comprises: a lower housing unit; an intermediate housing unit installed in an upper portion of the lower housing unit; and an upper housing unit installed in an upper portion of the intermediate housing unit. A plurality of intermediate housings are stacked to form the intermediate housing unit, and a heating unit to heat a blank is installed in each of the intermediate housings. Moreover, the intermediate housings are formed in the shape in which upper and lower portions thereof are opened, and an opening is formed in the front for a door to be inserted thereinto.

### TECHNICAL FIELD

The present invention relates to a multi-chamber type heating unit, and more particularly, to a multi-chamber type heating unit for allowing blanks made of a metallic material to be stacked in multistages and heated.

### BACKGROUND ART

Hot stamping is a method for increasing the strength of a metallic material by the quenching effect of heating a cold-rolled steel sheet, as an example of metallic material, at high temperatures by a heater, press-forming the heated metallic material, and then rapidly cooling the same in a mold.

This method can increase the strength of a metallic material while enhancing the formability to thus be used in the manufacture of automobile parts, for example, an impact beam, a center pillar, and the like.

A heater used in such a hot-stamping process includes an inline system for various processes such as the supply, cutting, heating, molding, and cooling of a steel sheet made of a metallic material, as disclosed in U.S. Pat. No. 6,564,604.

Thus, a hot-stamping line for manufacturing automobile parts occupy much installation space.

Further, since the heater needs to heat steel sheet blanks having been cut at high temperatures for several minutes, the heating process of the heater turns to a bottleneck process by which dead time occurs in the hot-stamping line.

### RELATED ART DOCUMENT

### Patent Document

(Patent Document 1) U.S. Pat. No. 6,564,604

### DISCLOSURE OF THE INVENTION

### Technical Problem

The present invention provides a multi-chamber type heating unit capable of efficiently performing a heating process for a blank while occupying less installation space.

### Technical Solution

In accordance with an embodiment of the present invention, a multi-chamber type heating unit for heating blanks includes: a lower housing portion; an intermediate housing portion provided on an upper portion of the lower housing portion; an upper housing portion provided on an upper portion of the intermediate housing portion, wherein the intermediate housing portion is formed by stacking a plurality of intermediate housings, heating units for heating the blanks are provided inside each of the intermediate housings, and the intermediate housing has open upper and lower portions and has an opening portion formed in the front thereof to insert a door.

The plurality of intermediate housings may be formed to be separable and mountable with each other in a height direction thereof.

The perimeter of the intermediate housing may have flanges such that the intermediate housings stacked in height direction are formed to be attachable and detachable from each other.

The door support portion for supporting the door may be formed on the perimeter of the opening portion formed in the front of the intermediate housing, the door support portion may be formed in a hollow shape, and the door support portion may have an inlet port and an outlet port through which a coolant is flowed and discharged.

The door may include: a sealing portion inserted into the door support portion; a front plate provided on the front of the sealing portion and formed to have a width greater than that of the sealing portion in a lateral direction thereof; and locking portions formed on the front plate.

The heating units may each include an heat transfer portion for emitting heat and a heat source portion provided on the heat transfer portion and may be laterally disposed on supports provided on the intermediate housing in the lateral direction.

The heat transfer portion may include a flat plate portion and blank support portions formed on an upper portion of the flat plate portion, and the blank support portions may be formed as a plurality of protrusion portions formed on the flat plate portion to be distanced from each other in the lateral direction.

The heat source portion may include: a metal hot wire disposed on a bottom surface of the flat plate portion; and hot wire support portions fixed to the flat plate portion to fix the metal hot wire.

The heating units may be disposed in a plurality of columns in a longitudinal direction thereof, and gaps between the plurality of protrusion portions forming the blank support portions may be provided to correspond to each other in the longitudinal direction of the housing unit.

The heat source portions of the heating units arranged in the longitudinal direction may be respectively and individually controlled in temperature by a control unit.

The heat source portion may not be provided in a portion, most adjacent to the door, of the heating units arranged in the longitudinal direction.

A temperature measurement part may be provided between the plurality of protrusion portions of the blank support portions in the longitudinal direction of the housing unit, and the temperature measurement part may be disposed below the blanks at positions at which the blanks are stacked.

The multi-chamber type heating unit may further include door sealing units provided on the intermediate housing portion and provided to seal the door when the door is closed.

The door sealing units may each include: a first actuator having one end rotatably fixed to the intermediate housing portion; and a link portion provided on the other end of the first actuator, and the link portion may have one end rotatably provided at a position adjacent to that of the door support portion of the intermediate housing portion and the other end rotatably provided on an end portion of the first actuator such that the link portion applies pressure to the door to seal the door by the operation of the first actuator.

The multi-chamber type heating unit may further include door moving units provided on both sides of the housing unit to be separated from the housing unit, and the door moving units each include: a column provided to extend in the height direction; an arm moving portion provided on the column and provided to be movable with respect to the column in the height direction and the longitudinal direction; and an arm portion provided on the arm moving portion and formed to be fastenable and unfastenable from the door.

The arm portion may include: an arm provided on the arm moving portion; a second actuator fixed to the arm and operated in the lateral direction, and a fastening portion fixed to an end portion of the second actuator and having locking grooves with an open shape corresponding to the locking portions formed on the door.

The respective locking grooves of the fastening portion of the door moving unit may be formed to be open toward the outside of the housing unit.

### Advantageous Effects

The present invention has an advantage that heating processes time for a plurality of blanks can be reduced while occupying less installation space.

Since an intermediate housing unit is formed by stacking a plurality of intermediate housings, the present invention is beneficial to installation and maintenance and repair work.

Further, the overall heat transfer efficiency may be improved by heating blanks by heating units provided immediately below the blanks and by an electric heater having a large surface area.

The internal temperature of a heating unit may be maintained to be suitable for heating the blanks by respectively and individually controlling the temperatures of the plurality of heating units arranged in the longitudinal direction.

Meanwhile, only a simple device configuration allows for sealing and unsealing of a door and moving of the door.

### BRIEF DESCRIPTION OF THE DRAWINGS

FIG. 1 is a perspective view of a multi-chamber type heating unit in accordance with the present invention.

FIG. 2 is an exploded perspective view of a housing unit in the multi-chamber type heating unit in accordance with the present invention.

FIG. 3 is a view illustrating a heating unit in the multi-chamber type heating unit in accordance with the present invention.

FIG. 4 illustrates a state in which the heating unit is provided in the housing unit in the multi-chamber type heating unit in accordance with the present invention.

FIG. 5 is a side section view of the multi-chamber type heating unit in accordance with the present invention.

FIG. 6 is a view illustrating a door sealing unit in the multi-chamber type heating unit in accordance with the present invention.

FIG. 7 is a view illustrating a door moving unit in the multi-chamber type heating unit in accordance with the present invention.

FIG. 8 is a view illustrating an arm portion in the multi-chamber type heating unit in accordance with the present invention.

FIGS. 9A to 9E are views illustrating an operating state of the multi-chamber type heating unit in accordance with the present invention.

### MODE FOR CARRYING OUT THE INVENTION

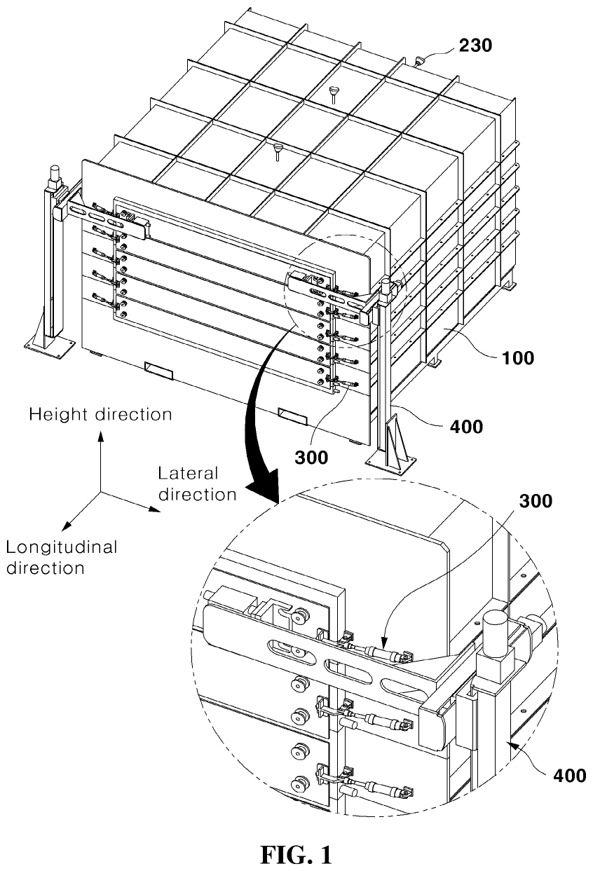

Hereinafter, embodiments of the present invention will be described with reference to the accompanying drawings. FIG. 1 is a perspective view of a multi-chamber type heating unit in accordance with the present invention.

A multi-chamber type heating unit 10, according to the present invention, includes a housing unit 100, heating units 200 provided inside the housing unit 100, door sealing units 300 on the housing unit 100, and door moving units 400 formed on the perimeter of the housing unit 100.

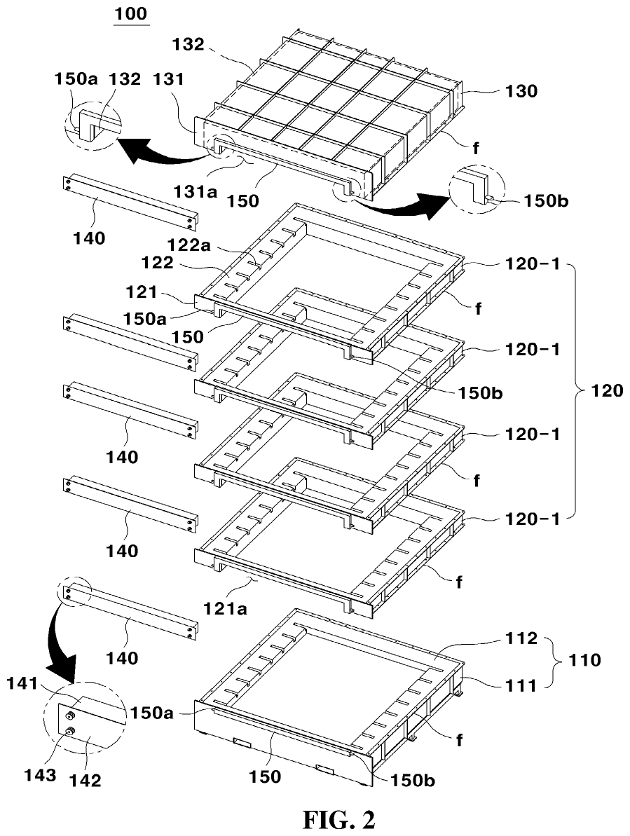

FIG. 2 is an exploded perspective view of a housing unit in the multi-chamber type heating unit in accordance with the present invention.

The housing unit 100 has a lower housing portion 110, an intermediate housing portion 120 provided on an upper portion of the lower housing portion 110, and an upper housing portion 130 provided on an upper portion of the intermediate housing portion 120.

The lower housing portion 110 has an approximately open upper portion and has a quadrangular box shape in the present embodiment.

The lower housing portion 110 includes a lower frame portion 111 made of a metallic material and a lower insulation wall portion 112 formed on the inner perimeter of the lower frame portion 111 and on a bottom surface and side surfaces of the lower frame portion 111.

An upper portion of the lower housing portion 110 has a door support portion 150 having a bar shape, the door support portion 150 has a hollow formed therein, and one end of the door support portion 150 has an inlet port 150a for allowing a coolant to be flowed therethrough and an outlet port 150b for allowing the coolant to be discharged therethrough.

It is preferable that the intermediate housing portion 120 is formed by stacking a plurality of intermediate housings 120-1.

The reason is that when outer portions of the intermediate housing portion 120 are formed into one and only the interior thereof is formed as the plurality of intermediate housings, the intermediate housing portion 120 is not easy to produce and beneficial to repair work when a problem occurs in a specific intermediate housing thereof.

Each of the intermediate housings 120-1 has open upper and lower portions and has a quadrangular box shape on the perimeter thereof in the present embodiment.

The intermediate housing 120-1 includes an intermediate frame portion 121 made of a metallic material and an intermediate insulation wall portion 122 formed on the inner perimeter of the intermediate frame portion 121.

The front of the intermediate frame portion 121 has an opening portion 121a, and the perimeter of the opening portion 121a has another door support portion 150 of which the front is open to support a door 140.

The door support portion 150 is made of the metallic material and the interior thereof is empty. The door support portion 150 is formed to be cooled by the coolant flowed through the inlet port 150a provided in one end of the door support portion 150 and discharged through the outlet port 150b provided in the other end of the door support portion 150.

Meanwhile, the upper and lower perimeters of the intermediate frame portion 121 each have a flange f such that the plurality of intermediate housings 120-1 are easily connected to each other.

Support grooves 122a for supporting the heating units 200 are formed on upper ends of the intermediate insulation wall portion 122 provided on both sides of the intermediate frame portion 121.

The door 140 includes a sealing portion 141 inserted into the opening portion 121a, a front plate 142 provided on the front of the sealing portion 141 and having a width greater than that of the sealing portion 141 in a lateral direction thereof, and locking portions 143 formed on the front plate 142.

The upper housing portion 130 is formed in a shape similar to that of the lower housing portion 110.

The upper housing portion 130 is formed in a quadrangular box shape having an approximately open lower portion.

The upper housing portion 130 includes an upper frame portion 131 made of a metallic material and an upper insulation wall portion 132 formed on the inner perimeter of the upper frame portion 131 and on a top surface and side surfaces of the upper frame portion 131.

The upper housing portion 130 also has another door support portion 150 formed on the perimeter of an opening portion 131a thereof, the door support portion 150 has a hollow formed therein, and one end of the door support portion 150 has an inlet port 150a for allowing the coolant to be flowed therethrough and an outlet port 150b for allowing the coolant to be discharged therethrough.

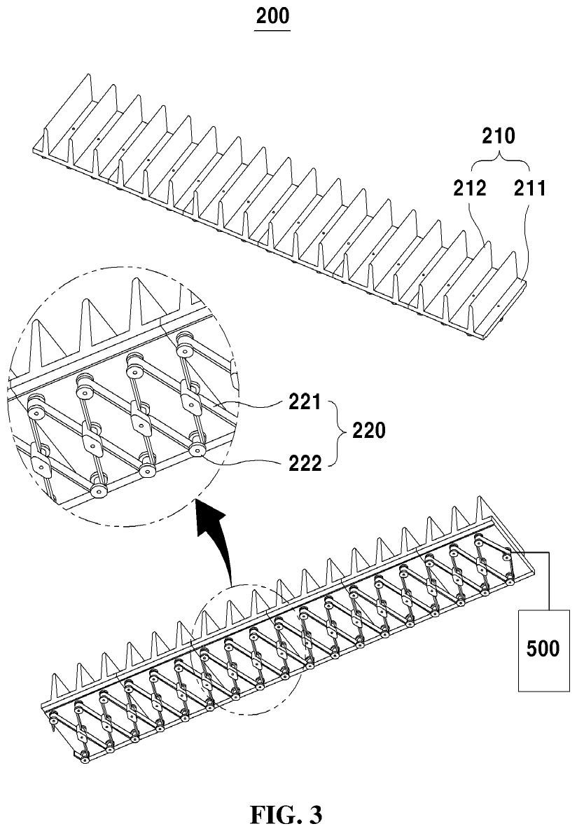

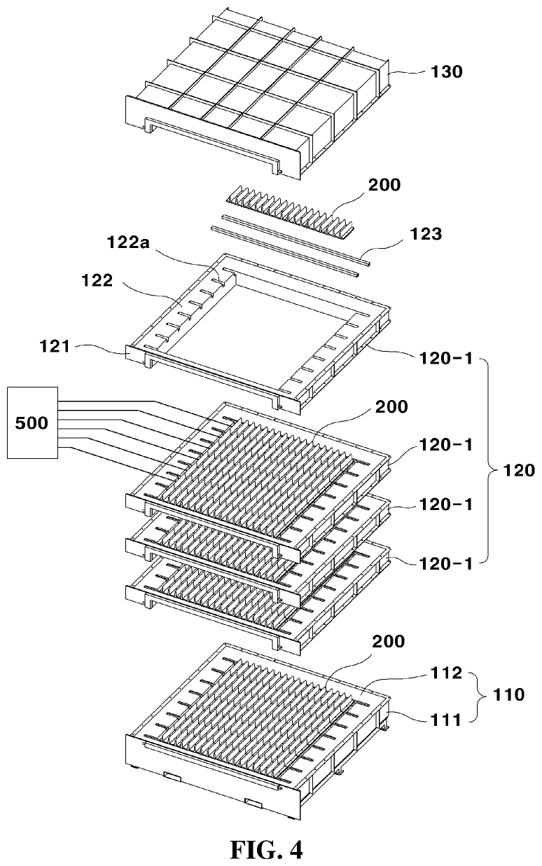

FIG. 3 is a view illustrating a heating unit in the multi-chamber type heating unit in accordance with the present invention. FIG. 4 illustrates a state in which the heating unit is provided in the housing unit in the multi-chamber type heating unit in accordance with the present invention.

The heating units 200 each include an heat transfer portion 210 for emitting heat and a heat source portion 220 provided on the heat transfer portion 210.

The heat transfer portion 210 includes a flat plate portion 211 and blank support portions 212 extending upward from the flat plate portion 211.

The blank support portions 212 are formed as a plurality of protrusion portions formed on the flat plate portion to be distanced from each other in the lateral direction.

Gaps between the blank support portions 212 are formed to be smaller than the lateral size of each of blanks b, but greater than the outer diameter of each of working pins p for inserting the blank b into a chamber and removing the same therefrom.

Supports 123 are provided on the support grooves 122a formed on the intermediate insulation wall portion 122 in the lateral direction, and the supports 123 have the heat transfer portions 210 provided thereon.

The heat transfer portion 210 is provided as one or a plurality of heat transfer portions 210 arranged in the lateral direction of the intermediate frame portion 121.

Further, the heat transfer portions 210 may be provided in a plurality of columns in a longitudinal direction thereof. At this time, the gaps between the protrusion portions 212 correspond to each other in the longitudinal direction of the housing unit 100.

The heat source portion 220 includes a metal hot wire 221 connected to a control unit 500 and hot wire support portions 222 for fixing the metal hot wire 221 to the flat plate portion 211.

In the present invention, the metal hot wire 221 is disposed immediately below a bottom surface of the flat plate portion 211 of the heat transfer portion 210 in the lateral direction, and the metal hot wire 221 is formed to be included in the area of the flat plate portion 211 as much as possible by being formed in a folded shape without being arranged in a straight line.

In the present embodiment, the heat transfer portion 210 is formed as a plurality of heat transfer portions in the lateral direction, and the heat source portion 220 is provided to connect in the lateral direction of the heat transfer portion 210.

Meanwhile, in the present embodiment, the heat transfer portions 210 are provided in the plurality of columns in the longitudinal direction, and the heat source portion 220 may not be provided on a portion, most adjacent to the door 140, of the heat transfer portions 210 in the longitudinal direction.

The reason is that opening and closing of the door 140 causes a heating temperature to be insufficient in the portion, adjacent to the door 140, of the heat transfer portions 210.

Power such as a current applied to the heat transfer portions 210 may also be individually controlled by the control unit 500 in each column in the longitudinal direction.

The reason is that when the same level of power is applied to the heat transfer portions 210 in the longitudinal direction, opening and closing of the door 140 causes a temperature required for processing of the blank b to be insufficient even in another heat transfer portion 210 next to a foremost heat transfer portion 210 in the column in the longitudinal direction other than the foremost heat transfer portion 210.

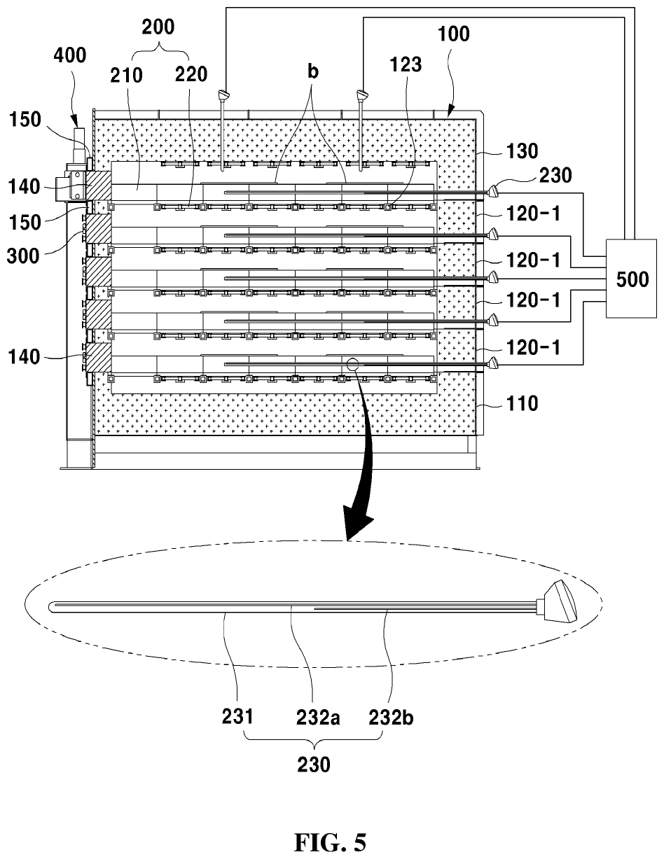

FIG. 5 is a side section view of the multi-chamber type heating unit in accordance with the present invention.

Meanwhile, a temperature measurement part 230 is provided immediately below positions at which the blanks b are stacked through each of the gaps between the blank support portions 212 from a rear surface of the intermediate housing 120-1 in the longitudinal direction.

The temperature measurement part 230 includes a protective tube 231 extending in the longitudinal direction and a thermometer 232 provided inside the protective tube 231 and extending in the longitudinal direction to be provided at the positions at which the blanks b are stacked.

The protective tube 231 of the temperature measurement part 230 protects the thermometer 232 from the inner high temperature of the multi-chamber type heating unit 10.

A sheath type temperature sensor, for example, a thermocouple type thermometer, is used as the thermometer 232.

The thermometer 232 is provided as many as the number of blanks b. In the present embodiment, two blanks b are stacked in the longitudinal direction, and the thermometer 232 thus includes two thermometers 232a and 232b having different lengths in the longitudinal direction.

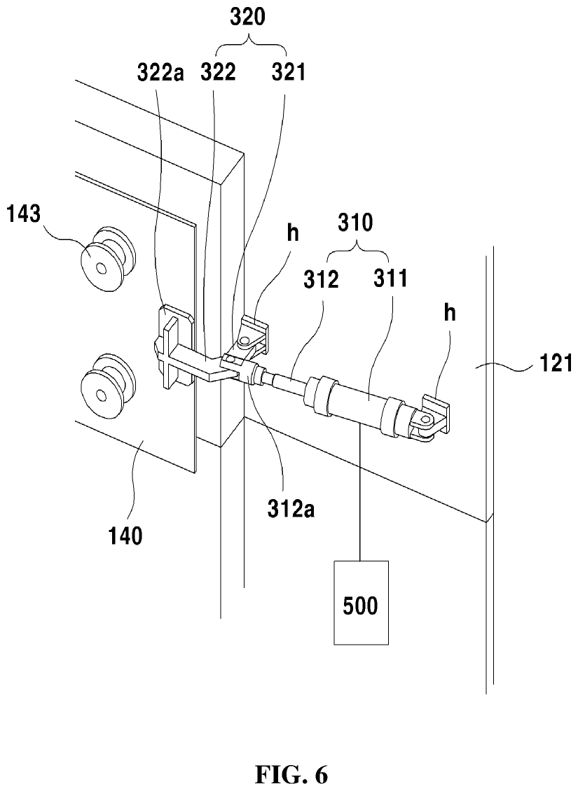

FIG. 6 is a view illustrating a door sealing unit in the multi-chamber type heating unit in accordance with the present invention.

Both sides of the intermediate housing 120-1 have a pair of door sealing units 300 for fixing the door 140.

The door sealing units 300 each include a first actuator 310 connected to the control unit 500 and a link portion 320 fixed to an end portion of the first actuator 310.

The first actuator 310 includes a cylinder 311 having one end rotatably fixed by a hinge h to an end portion of the intermediate frame portion 121 of the intermediate housing 120-1 and a rod 312 formed on the other end of the cylinder 311.

The link portion 320 is fixed to a bracket 312a provided on an end portion of the rod 312.

The link portion 320 includes a first link 321 having one end portion rotatably fixed by the hinge h to a position adjacent to that of the door support portion 150 and the other end portion fixed to the bracket 312a and a second link 322 having one end portion fixed to the other end portion of the first link 321 and the other end portion fixed to a pressure plate 322a.

The first link 321 and the second link 322 are formed to have an angle therebetween and fixed to the bracket 312a at the intersection of the angle.

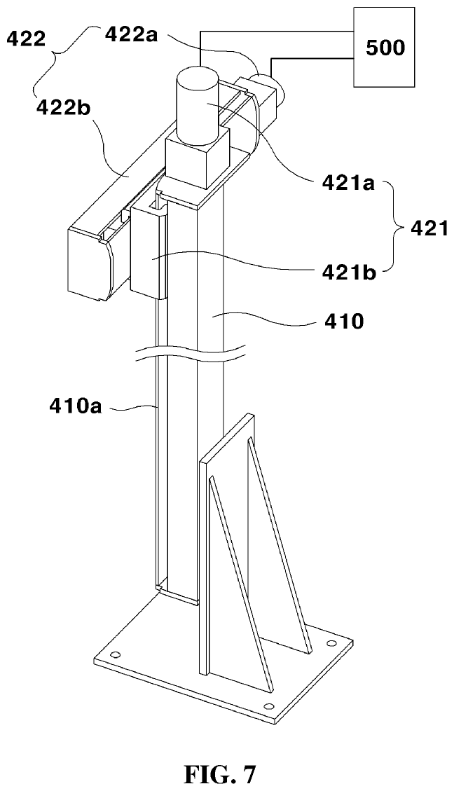

FIG. 7 is a view illustrating a door moving unit in the multi-chamber type heating unit in accordance with the present invention.

Meanwhile, both sides of the housing unit 100 have a pair of door moving units 400.

The door moving units 400 each include a column 410 provided to extend in a height direction thereof, an arm moving portion 420 provided on the column 410 and connected to the control unit 500, and an arm portion 430 provided on the arm moving portion 420.

It is preferable that the column 410 is provided distinct from the housing unit 100. The reason is that in the present invention, the intermediate housing 120-1 can be formed to be able to individually separate and repair, and at this time, when the column 410 is provided adjacent to the housing unit 100, individual removal and installation of the intermediate housing 120-1 is inconvenient or difficult.

The arm moving portion 420 provided on the column 410 includes a height direction moving portion 421 for moving the arm portion 430 in the height direction and a longitudinal direction moving portion 422 for moving the arm portion 430 in the longitudinal direction.

The height direction moving portion 421 and the longitudinal direction moving portion 422 are formed as a known linear moving device of a linear motion (LM) guide or ball screw type.

For example, the height direction moving portion 421 includes a first drive motor 421a connected to the control unit 500 and a slider 421b driven by the first drive motor 421a to move along a rail 410a formed on the column 410 in the height direction by the known linear moving device (not illustrated) of a ball screw type or the like.

Further, the longitudinal direction moving portion 422 includes a second drive motor 422a and a rail 422b driven by the second drive motor 422a to relatively move with respect to the slider 421b in the longitudinal direction by the known linear moving device (not illustrated) of a ball screw type or the like.

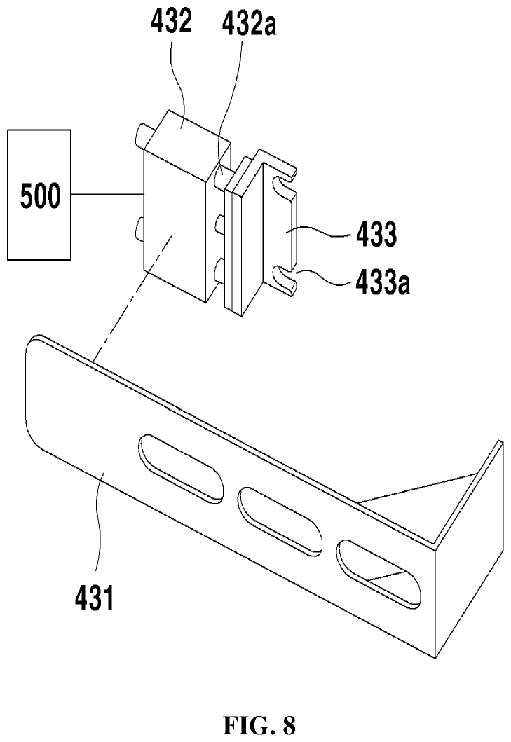

FIG. 8 is a view illustrating an arm portion in the multi-chamber type heating unit in accordance with the present invention.

Meanwhile, the arm portion 430 includes an arm 431 fixed to the rail 422b of the longitudinal direction moving portion 422, a second actuator 432 fixed to the arm 431, operated by the control unit 500 in the lateral direction, and having rods 432a, and a fastening portion 433 fixed to end portions of the rods 432a of the second actuator 432.

The fastening portion 433 is formed in a bracket shape and has locking grooves 433a having a groove shape and opened to correspond to the locking portions 143.

In the present invention, the door moving units 400 are formed as a pair on both sides of the housing unit 100. Thus, the fastening portion 433 is formed on each of both sides thereof. At this time, the direction of the locking grooves 433a of the fastening portion 433 is oriented such that the locking grooves 433a are open toward the outside of the housing unit 100 in an opposite direction.

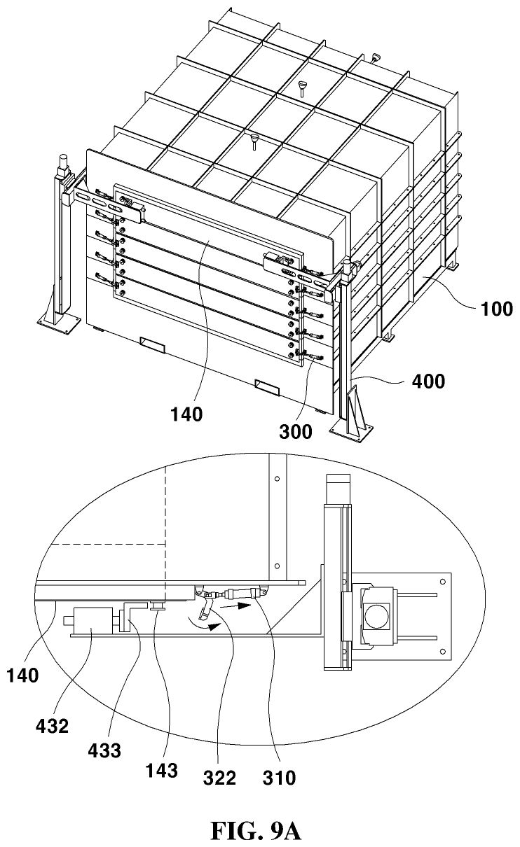

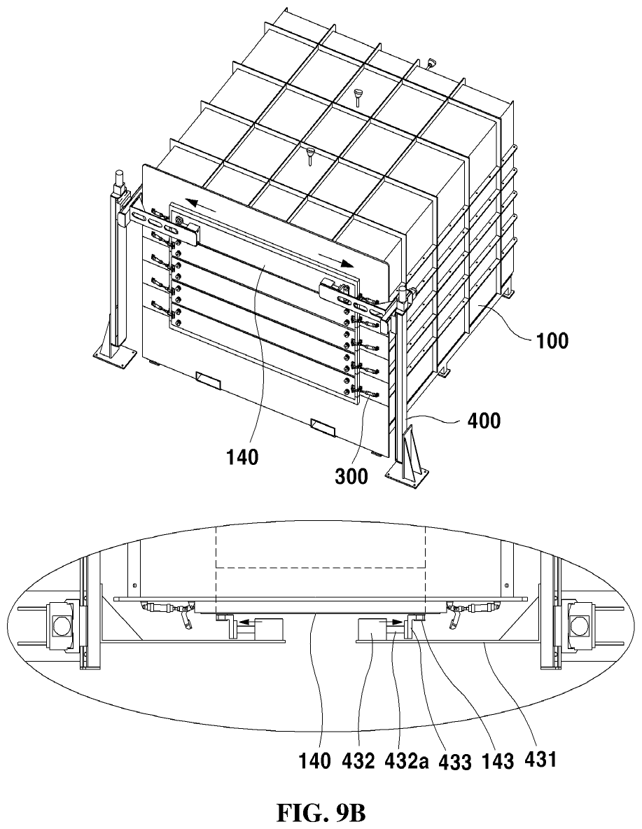

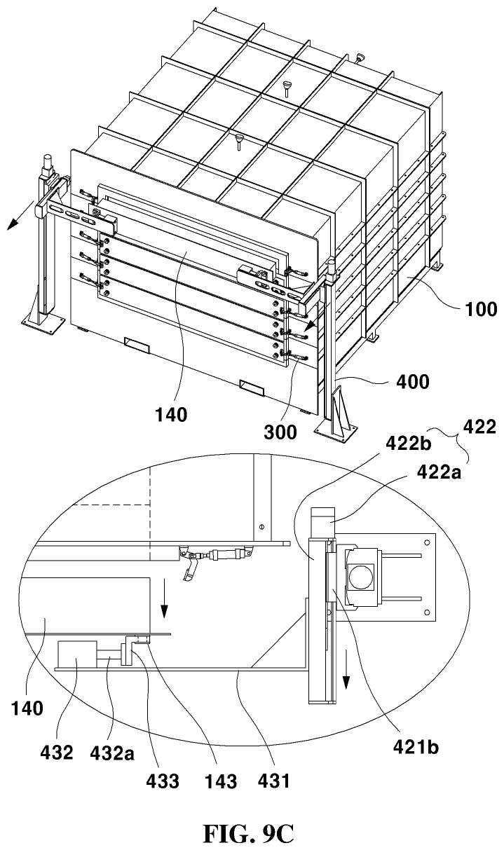

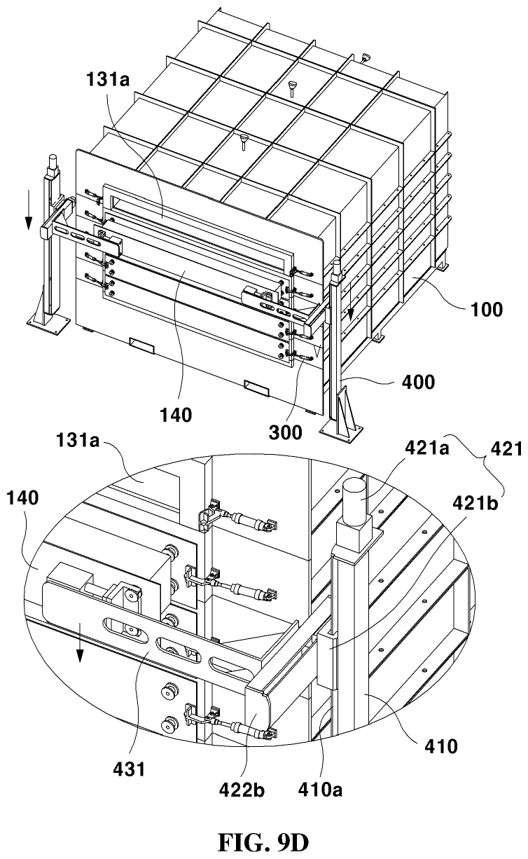

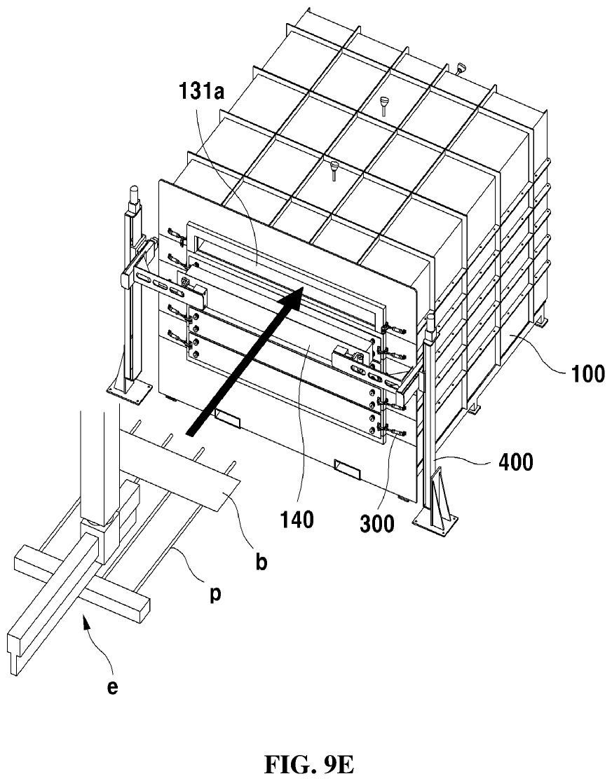

Next, the operation of the multi-chamber type heating unit configured as described above will be described with reference to the drawings. FIGS. 9A to 9E are views illustrating an operating state of the multi-chamber type heating unit in accordance with the present invention.

First, an operation of removing the door 140 from the intermediate housing 120-1 is performed to open the intermediate housing 120-1 to which the blanks b are to be inserted.

As illustrated in FIG. 9A, when the operation of the first actuator 310 is cancelled by the control unit 500, rotation of the link portion 320 allows the second link 322, which has applied pressure to the door 140, to be rotated such that a pressurized state of the door 140 is released and the link portion 320 is moved to a position at which the same does not interfere with a longitudinal movement of the door 140.

Next, as illustrated in FIG. 9B, when the second actuator 432 is operated by the control unit 500, the locking grooves 433a of the fastening portion 433 fixed to an end portion of the second actuator 432 are inserted into the locking portions 143 formed on the front of the door 140.

At this time, the respective locking grooves 433a of the fastening portion 433 are formed to be open toward both sides of the housing unit 100, and two second actuators 432 respectively perform pushing to outer end portions of the housing unit 100 such that the door 140 is strongly fastened to the arm portion 430. Thus, the door 140 is stably moved even when the door 140 is moved in the longitudinal direction or the height direction.

Further, the door 140 may be strongly supported only by simply forming the locking grooves of the fastening portion 433 of the arm portion 430 in an open shape. Thus, a device for moving the door may be simply configured.

Then, as illustrated in FIG. 9C, the second drive motor 422a of the longitudinal direction moving portion 422 is operated such that the rail 422b is relatively moved forward with respect to the slider 421b in the longitudinal direction, thereby moving the arm portion 430, to which the door 140 is fastened, forward in the longitudinal direction.

Next, as illustrated in FIG. 9D, the first drive motor 421a of the height direction moving portion 421 is operated such that the slider 421b is slid along the rail 410a formed on the column 410 in the height direction, thereby moving the arm portion 430, to which the door 140 is fastened, upward or downward in the height direction.

By the operations described above, the operation of removing the door 140 is completed before insertion of the blanks b.

Next, as illustrated in FIG. 9E, the blanks b are stacked on upper portions of insertion pins p of a blank insertion device e provided on the outside to insert the blanks b into the multi-chamber type heating unit 10.

The insertion pins p, on which the blanks b are stacked, are inserted into the door support portion 150 of the housing unit 100 at a height corresponding to that of upper portions of the blank support portions 212 in the longitudinal direction.

Then, when the insertion pins p are moved downward, the insertion pins p are inserted into the gaps between the protrusion portions of the blank support portions 212, and the blanks b are seated on upper surfaces of the blank support portions 212.

The stacking of the blanks b is completed by retracting the insertion pins p backward in the longitudinal direction and removing the same from the housing unit 100.

Next, an operation of fastening the door to the intermediate housing on which the blanks b are stacked is performed.

First, while the door 140 is fastened to the intermediate housing 120-1 into which the blanks b are inserted, the height direction moving portion 421 of the arm moving portion 420 having been positioned thereabove or therebelow is operated by the control unit 500 such that the height direction moving portion 421 is positioned on the door support portion 150 of the intermediate housing 120-1.

Then, the door 140 is inserted into the door support portion 150 by the longitudinal direction moving portion 422.

At this time, the front plate 142 of the door 140 has a width greater than that of the sealing portion 141, which is to be inserted into the door support portion 150, in the lateral direction, and the door 140 thus functions as a stopper for preventing the door 140 from being inserted thereinto any more.

Next, the control unit 500 operates the first actuator 310 of the door sealing unit 300 so as to rotate the link portion 320 such that the pressure plate 322a formed on the second link 322 applies pressure to the front plate 142 of the door 140, thereby sealing the door 140.

Such an operation of sealing the door 140 is performed in order reverse to that of the operation of unsealing the door 140 in FIGS. 9A to 9D, as described above.

Meanwhile, when the operation of arranging the blanks b inside the housing unit 100 is completed, a process of heating the blanks b is performed.

The control unit 500 allows electricity to be applied to the heat source portion 220 such that resistance heat is generated in the metal hot wire 221 and transferred to the heat transfer portion 210.

In the present invention, the metal hot wire 221 is provided on the bottom surface of the flat plate portion 211 in a folded state such that the metal hot wire 221 having a length greater than that of the flat plate portion is disposed as compared to that when the metal hot wire 221 is formed in a linear shape in the lateral direction, thereby further increasing calorific value per unit area.

Moreover, in the present invention, heat is generated immediately below the flat plate portion 211 of the heat transfer portion 210 such that the heat is directly transferred to the flat plate portion 211 without loss, thereby increasing heat transfer efficiency.

Thus, the efficiency of heat transfer to the blanks b is significantly increased as compared to that when a heat source portion is provided on the perimeter of a conventional heating unit rather than in the center thereof.

Further, the blank support portions 212 of the heat transfer portion 210 are formed in the shape of a protrusion portion to thus have a large surface area, thereby being beneficial to transfer of heat to the blanks b.

As described above, in the present invention, an operation of heating the blanks b is alternately performed in the respective intermediate housings 120-1 stacked in multistages. Thus, an installation space is reduced and heat treatment processing time is reduced as compared to those when a conventional continuous furnace type heating unit extending in a longitudinal direction thereof is used.

Meanwhile, while the blanks b are heated, the coolant continues to be circulated through the inlet port 150a and the outlet port 150b of the door support portion 150 so as to cool the door support portion 150.

The reason is that when the door support portion 150 made of a metallic material or the like is not cooled, the door 140 is not easily inserted and removed due to thermal deformation thereon.

Further, in the present invention, the temperature measurement part 230 is provided immediately below the blanks b, and a temperature affecting the blanks b may thus be accurately measured.

In the present invention, the control unit 500 may control the temperatures of the respective heat transfer portions 210 arranged in the longitudinal direction to prevent a difference in temperature between the heat transfer portions 210 arranged in the longitudinal direction due to temperature nonuniformity inside multi-chambers caused by opening and closing of the door 140 or to a factor such as an external environment or the like in which the multi-chamber type heating unit 10 is provided, thereby ensuring reliability of a heat treatment on a product.

Meanwhile, the temperature measured by the temperature measurement part 230 is transmitted to the control unit 500, and when a preset temperature is not maintained or variations thereof occur, necessary maintenance work is performed.

When the maintenance work is performed, only a defective intermediate housing 120-1 may be separated from the plurality of stacked intermediate housings 120-1 and repaired, as described above.

Further, the column 410 is formed to be separated from the housing unit 100. Thus, when the intermediate housing 120-1 is separated or reassembled for repair or the like, the column 410 is prevented from interfering with the same.

The above embodiments are illustrative of the technical spirit of the present invention, and similar technical spirits are included in the scope of the claims without departing from the scope of the present invention.

1. A multi-chamber type heating unit for heating blanks comprising:
a lower housing portion;
an intermediate housing portion provided on an upper portion of the lower housing portion;
an upper housing portion provided on an upper portion of the intermediate housing portion,
wherein the intermediate housing portion is formed by stacking a plurality of intermediate housings, heating units for heating the blanks are provided inside each of the intermediate housings, and the intermediate housing has open upper and lower portions and has an opening portion formed in the front thereof to insert a door.

2. The multi-chamber type heating unit of claim 1, wherein the plurality of intermediate housings are formed to be separable and mountable with each other in a height direction thereof.

3. The multi-chamber type heating unit of claim 2, wherein the perimeter of the intermediate housing has flanges such that the intermediate housings stacked in height direction are formed to be attachable and detachable from each other.

4. The multi-chamber type heating unit of claim 3, wherein a door support portion for supporting the door is formed on the perimeter of the opening portion formed in the front of the intermediate housing, the door support portion is formed in a hollow shape, and the door support portion has an inlet port and an outlet port through which a coolant is flowed and discharged.

5. The multi-chamber type heating unit of claim 4, wherein the door includes: a sealing portion inserted into the door support portion; a front plate provided on the front of the sealing portion and formed to have a width greater than that of the sealing portion in a lateral direction thereof; and locking portions formed on the front plate.

6. The multi-chamber type heating unit of claim 5, wherein the heating units each include a heat transfer portion for emitting heat and a heat source portion provided on the heat transfer portion and are laterally disposed on supports provided on the intermediate housing in the lateral direction.

7. The multi-chamber type heating unit of claim 6, wherein the heat transfer portion includes a flat plate portion and blank support portions formed on an upper portion of the flat plate portion, and the blank support portions are formed as a plurality of protrusion portions formed on the flat plate portion to be distanced from each other in the lateral direction.

8. The multi-chamber type heating unit of claim 7, wherein the heat source portion includes: a metal hot wire disposed on a bottom surface of the flat plate portion; and hot wire support portions fixed to the flat plate portion to fix the metal hot wire.

9. The multi-chamber type heating unit of claim 8, wherein the heating units are disposed in a plurality of columns in a longitudinal direction thereof, and gaps between the plurality of protrusion portions forming the blank support portions are provided to correspond to each other in the longitudinal direction of the housing unit.

10. The multi-chamber type heating unit of claim 9, wherein the heat source portions of the heating units arranged in the longitudinal direction are respectively and individually controlled in temperature by a control unit.

11. The multi-chamber type heating unit of claim 10, wherein the heat source portion is not provided in a portion, most adjacent to the door, of the heating units arranged in the longitudinal direction.

12. The multi-chamber type heating unit of claim 12, wherein a temperature measurement part is provided between the plurality of protrusion portions of the blank support portions in the longitudinal direction of the housing unit, and the temperature measurement part is disposed below the blanks at positions at which the blanks are stacked.

13. The multi-chamber type heating unit of claim 12, further comprising door sealing units provided on the intermediate housing portion and provided to seal the door when the door is closed.

14. The multi-chamber type heating unit of claim 13, wherein the door sealing units each include: a first actuator having one end rotatably fixed to the intermediate housing portion; and a link portion provided on the other end of the first actuator, and the link portion has one end rotatably provided at a position adjacent to that of the door support portion of the intermediate housing portion and the other end rotatably provided on an end portion of the first actuator such that the link portion applies pressure to the door to seal the door by the operation of the first actuator.

15. The multi-chamber type heating unit of claim 14, further comprising door moving units provided on both sides of the housing unit to be separated from the housing unit, and the door moving units each include: a column provided to extend in the height direction; an arm moving portion provided on the column and provided to be movable with respect to the column in the height direction and the longitudinal direction; and an arm portion provided on the arm moving portion and formed to be fastenable and unfastenable from the door.

16. The multi-chamber type heating unit of claim 15, wherein the arm portion includes: an arm provided on the arm moving portion; a second actuator fixed to the arm and operated in the lateral direction, and a fastening portion fixed to an end portion of the second actuator and having locking grooves with an open shape corresponding to the locking portions formed on the door.

17. The multi-chamber type heating unit of claim 16, wherein the respective locking grooves of the fastening portion of the door moving unit are formed to be open toward the outside of the housing unit.
